(19) United States
(12) Patent Application Publication
(10) Pub. No.: US 2009/0171743 A1
(43) Pub. Date: Jul. 2, 2009

(54) SERVICE REQUEST SYSTEM WITH NATURAL SERVICE PROVIDER PROFILING AND METHODS THEREOF

(76) Inventors: Dana SPIEGEL, Brooklyn, NY (US); Gabe Miano, Boston, MA (US); Lauren Macleod, Rye, NY (US); Paul Nadjarian, New York, NY (US); Jose Bernal, Andover, MA (US); Chris Cheng, New York, NY (US); Kate Grinney, New York, NY (US)

Correspondence Address: BLANK ROME LLP, WATERGATE, 600 NEW HAMPSHIRE AVENUE, N.W., WASHINGTON, DC, 20037, US

(21) Appl. No.: 11/968,302

(22) Filed: Jan. 2, 2008

(51) Int. Cl. G06Q 10/00

(52) U.S. Cl. 705/9

(57) ABSTRACT

A system and method for managing service requests performs the steps of loading profile settings for service providers, where the profile settings comprise a two dimensional matrix of actions and objects, processing a work order by determining task involved in the accomplishment of the work order, mapping the profile settings into a hierarchy of determined tasks of the work order and providing a listing of service providers for the work order through results of the mapping step.

### FIELD OF THE INVENTION

The subject invention relates generally to a system and method for managing requests for services. More specifically, the present invention is directed to a system that allows for enhanced profiling and selection of service providers, to enhance the overall process.

### DESCRIPTION OF RELATED ART

A need presently exists for an improved system and method for requesting, deploying, managing, and delivering services. This need is especially felt by relatively medium to larger sized companies with multiple geographic locations and complex multi-vendor environments and also by smaller companies. Employing full-time, on-site service personnel at many such locations is generally not feasible given the associated costs. As such, to have their service needs fulfilled, such as, for example, computer services, these smaller branch offices must rely on support from a centralized source, engage local companies/consultants, and/or contract with a service firm that are alleged to have national coverage.

In the areas of information technology, in instances where a branch office relies on assistance from a corporate help desk to address their computer service needs, technology is presently available that allows a service provider to remotely access a computer for the purpose of attempting to solve certain problems that may exist. However, not all problems are capable of being solved in this manner, e.g., problems associated with computers that are not capable of being turned on, printers that are jammed, cables that are broken, etc. Thus, to meet branch office demands for computer services arising from problems that cannot be serviced via the use of remote access software, the only alternative left for a centralized help desk is to request that the equipment experiencing the problem be sent out for repair or to send a technician to the branch office to solve the problem. Undesirably, performing repair services in this manner is inefficient and costly, especially when the service request results from a problem that is relatively minor. Furthermore, there exists a cost that is associated with the time of lost access to the equipment in that employees at the branch office may not be capable of performing their required work without the operable equipment.

When branch or remote offices are authorized to engage local companies for the purpose of addressing their computer service needs, other problems tend to arise. In this regard, problems may be created for the help desk as they attempt to manage the arrangement of services throughout the entirety of a company at all of the different locations. Further problems arise from the need to budget and manage the costs associated with requesting services in this manner. By way of example, if a company has three hundred locations, that may equate to three hundred computer service vendors, with three hundred different prices for parts and hourly service rates, with three hundred different response times, etc. Thus, for companies having multiple geographic locations and complex multi-vendor computer environments, the problems associated with contracting service professionals, e.g., coordinating accounting, paying large quantities of small invoices, etc., can become very burdensome.

To address some of these problems, a company can contract with a large service provider company, for example, IBM, EDS or CSC. However, while large service providers can deploy services that are generally consistent around the country and the contracting company would have only one vendor with one price for parts and labor, these contracts are usually limited in scope and extremely costly. In this regard, service contracts usually cover only hardware and act like extended warranties. Thus, if a company requests services in an area that falls into a category not covered under contract, the hourly rates can become exorbitantly high. In addition, the most comprehensive on-site contracts still leave open ends for equipment covered under warranty, software problems, new system roll-outs and other upgrades. Still further, large service providers often utilize the services of sub-contractors which makes it increasingly difficult if not impossible for service buyers to track the progress of service requests. To further complicate matters, large service providers often try to protect or mask their use of sub-contractors so as to give the appearance of providing a comprehensive service solution.

One such system that addresses the concerns is the system and methods discussed in U.S. application Ser. No. 10/755,569, “System and Method for Managing Accounts Payable and Accounts Receivable,” filed Jan. 12, 2004, assigned to the assignee of the present application. This application is incorporated by reference. The system and method allows for management of service requests, including controlling, building, and deploying a scalable workforce to solve service related problems quickly and efficiently. The subject system and method allow any business to create and manage a service department, with the creation and management of the service department performed via the Internet. The subject system is also used by a service buyer to monitor and pay for services. While this system overcomes the problems noted above, it does not explicitly address some issues involved with such systems.

One such issue occurs because an online system provides specific ways for user to set up their profiles. In these systems, the profile is generated by the service requests that a service provider will accept, for example, and does not naturally comport with the way a service provider might market themselves to other customers not involved in the system. The service provider may have special talents or experiences that are not captured when a provider is requested to indicate what types of service requests they will field. Buyers often have an interest in finding service providers that have special interests or experience in fulfilling their particular service request. If such advanced profiling can be implemented, it can enhance the overall experiences for all users of the system.

Thus, there is a need for a system that allows service buyers and providers to provide fuller descriptions of their needs and abilities that are not limited to filling out of simple forms. There is also a need for methods that will allow for the profiling process to be decoupled from work order categories in ways that were not previously available.

### SUMMARY OF THE INVENTION

It is therefore an object of the invention to allow service buyers and providers to interact electronically to fulfill work orders, where changes can be made to the work orders and the changes can be incorporated into the work order process. Another object of the invention is to provide methods that will allow for refinement of work orders that do not hamper the process of fulfilling those work orders and allow all parties to fully understand all terms redefined.

To achieve the above and other objects, the present invention is directed to a system that allows for refinement of requests for services before those requests for service have been accepted. The present invention overcomes the disadvantages of the prior art systems discussed above.

According to at least one embodiment, the invention is directed to a processing system having instructions for managing service requests which performs the steps of loading profile settings for service providers, where the profile settings comprise a two dimensional matrix of actions and objects, processing a work order by determining task involved in the accomplishment of the work order, mapping the profile settings into a hierarchy of determined tasks of the work order and providing a listing of service providers for the work order through results of the mapping step.

In specific embodiments, the system may also include instructions for requesting additional characteristics for the service provider and including the additional characteristics in the saved, profile settings. The instructions for loading profile settings for a service provider may include updating old profile settings for the service provider. The step of providing a listing of service providers may include a listing of service providers ranked by a fit of service providers with the hierarchy of determined tasks. The instructions for loading profile settings for a service provider may also include loading default settings for a new service provider.

In addition, the instructions may include requesting certification information for the service provider or requesting experience information for specific brands of equipment. The instructions for requesting experience information for specific brands of equipment may include requesting experience information for at least one of point of sale brands, printer brands and voice over IP brands. Note that these instructions can be generalized and can be applied to more types of brands. The instructions may include requesting languages spoken by the service provider. The two dimensional matrix of actions and objects may be a two dimensional matrix of actions and objects having non-binary values for matrix values.

According to at least another embodiment, a method for managing service requests, the method includes loading profile settings for service providers, where the profile settings comprise a two dimensional matrix of actions and objects, processing a work order by determining task involved in the accomplishment of the work order, mapping the profile settings into a hierarchy of determined tasks of the work order and providing a listing of service providers for the work order through results of the mapping step.

### BRIEF DESCRIPTION OF THE DRAWINGS

A preferred embodiment of the present invention will be set forth in detail with reference to the drawings, in which:

FIG. 1 illustrates a block diagram of an exemplary computer system in which the principles of the subject invention may be employed;

FIG. 2 illustrates a process flow diagram of an exemplary method for managing service requests, according to one aspect of the present invention;

FIG. 3 illustrates a further process flow diagram of the exemplary method for managing service requests with a particular focus on the service buyer, according to one aspect of the present invention;

FIG. 4 illustrates a further process flow diagram of the exemplary method for managing service requests with a particular focus on the service provider, according to one aspect of the present invention;

FIG. 5 illustrates the service profile creation process, according to one embodiment of the present invention;

FIG. 6 illustrates another portion of the service profile creation process, according to one embodiment of the present invention;

FIG. 7 illustrates another portion of the service profile creation process, according to one embodiment of the present invention;

FIG. 8 illustrates another portion of the service profile creation process, according to one embodiment of the present invention;

FIG. 9 illustrates a two-axis matrix matching provider's profiles and work order categories, according to one embodiment of the present invention;

FIG. 10 illustrates a screen shot of a service profiles list page, according to one embodiment of the present invention;

FIG. 11 illustrates a screenshot of a user setting page, according to one embodiment of the present invention;

FIG. 12 illustrates a screenshot of a service profile skills page, according to one embodiment of the present invention;

FIG. 13 illustrates a screenshot of a point of sale brand page, according to one embodiment of the present invention;

FIG. 14 illustrates a screen-shot of a printer brands page, according to one embodiment of the present invention;

FIG. 15 illustrates a screenshot of a voice over IP brands page, according to one embodiment of the present invention;

FIG. 16 illustrates a screenshot of an additional service profile information page, according to one embodiment of the present invention;

FIG. 17 illustrates a screen-shot of another portion of the additional service profile information page, according to one embodiment of the present invention;

FIG. 18 illustrates a screenshot of a work order preferences page, according to one embodiment of the present invention;

FIG. 19 illustrates a screenshot of a certifications page, according to one embodiment of the present invention;

FIG. 20 illustrates a screen-shot of a service profile review page, according to one embodiment of the present invention;

FIG. 21 illustrates a screenshot of another portion of the service profile review page, according to one embodiment of the present invention;

FIG. 22 illustrates a screen-shot of a public profile page, according to one embodiment of the present invention; and

FIG. 23 illustrates a flow chart for the process of refining a work order before it has been accepted.

### DETAILED DESCRIPTION OF THE INVENTION

The present invention will be set forth in detail with reference to the drawings, in which like reference numerals refer to like elements or operational steps throughout. The following descriptions provide examples of how to implement the present invention, but are not the only implementations possible. The examples that are described herein have been chosen for their illustrative power in explaining at least one aspect of the present invention and have been shown to have utility in carrying out the objectives of the present invention.

Although not required, the system and method will be described in the general context of computer executable instructions being executed by one or more processing devices such as a personal computer, mainframe computer, personal-digital assistant (“PDA”), cellular telephone, or the like. Generally, the computer executable instructions reside in program modules which may include routines, programs, objects, components, data structures, etc. that perform particular tasks or implement particular abstract data types. In this regard, those skilled in the art will appreciate that the system and method described hereinafter may also be practiced in distributed computing environments where tasks are performed by various processing devices that are linked through a communication network and where program modules may be located in both local and remote memory storage devices associated with such processing devices.

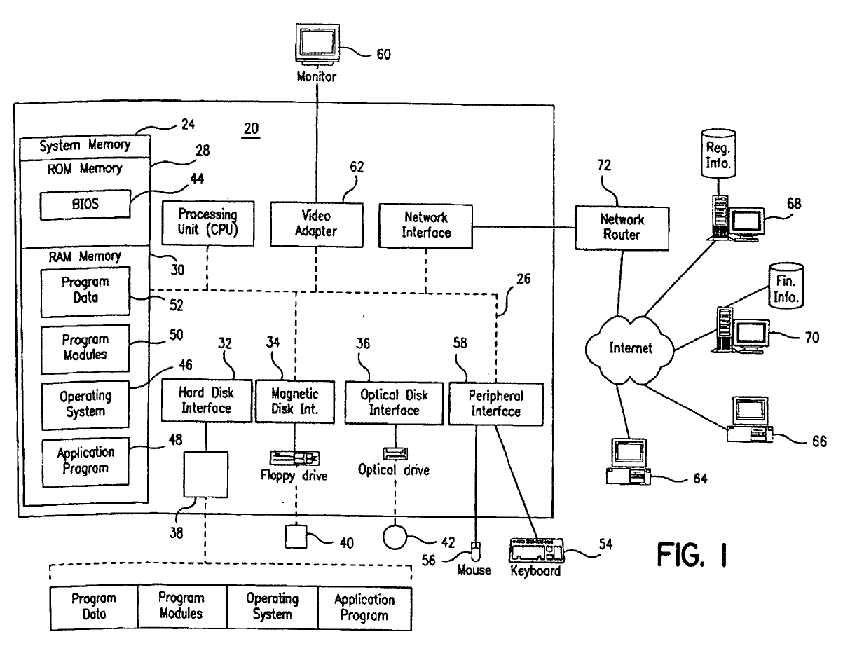

A network system in which the subject system and method may reside is illustrated by way of example in FIG. 1. In the illustrated network system, a Command Center 20, illustrated in the exemplary form of a computer system, is provided to manage service requests in a manner that will be described in greater detail hereinafter. While described and illustrated as a single computer system, it is again emphasized that the Command Center 20 may be implemented such that tasks are performed by various processing devices that are linked through a communication network such as the Internet, LAN, or the like.

For performing the various tasks, the Command Center 20 preferably includes a processing unit 22 and a system memory 24 which may be linked via a bus 26. Without limitation, the bus 26 may be a memory bus, a peripheral bus, and/or a local bus using any of a variety of bus architectures. By way of further example, the bus 26 may include an architecture having a North Bridge and a South Bridge where the North Bridge acts as the connection point for the processing unit 22, memory 24, and the South Bridge. The North Bridge functions to route traffic from these interfaces, and arbitrates and controls access to the memory subsystem from the processing unit 22 and I/O devices. The South Bridge, in its simplest form, integrates various I/O controllers, provides interfaces to peripheral devices and buses, and transfers data to/from the North bridge through either a PCI bus connection in older designs, or a proprietary interconnect in newer chipsets.

As needed for any particular purpose, the system memory 24 may include read only memory (ROM) 28 and/or random access memory (RAM) 30. Additional memory devices may also be made accessible to the Command Center 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the Command Center 20. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nanodrives, memory sticks, and other read/write and/or read-only memories.

A number of program modules may be stored in one or more of the memory/media devices. For example, a basic input/output system (BIOS) 44, containing the basic routines that help to transfer information between elements within the Command Center 20, such as during start-up, may be stored in ROM 24. Similarly, the RAM 30 and/or the hard drive 38 may be used to store computer executable instructions comprising an operating system 46, one or more applications programs 48, other program modules 50, and/or program data 52.

A user may enter commands and information into the Command Center 20 through input devices such as a keyboard 54 and/or a pointing device 56. While not illustrated, other input devices may include a microphone, a joystick, a game pad, a scanner, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the Command Center 20, a monitor 60 or other type of display device may also be connected to the bus 26 via an interface, such as video adapter 62. In addition to the monitor 60, the Command Center 20 may also include other peripheral output devices, not shown, such as speakers and printers.

For operating in a networked environment, such as the Internet, the Command Center 20 utilizes logical connections to one or more remote processing devices, such as client computer 64, technician computer 66, database computer 68, and/or financial institution computer 70. In this regard, while the remote processing devices have been illustrated in the exemplary form of computers, it will be appreciated that the remote processing devices may be any type of device having processing capabilities and/or the ability to establish a communication link with the Command Center 20 such as, for example, a cellular telephone.

Again, the illustrated processing devices need not be implemented as a single device but may be implemented in a manner such that the tasks performed by the various processing devices are distributed to a plurality of processing devices linked through a communication network. Thus, the remote processing devices may include many or all of the elements described above relative to the Command Center 20 including the memory storage devices and a display device. The connection between the Command Center 20 and the remote processing devices is typically made through a further processing device 72 that is responsible for network routing. Furthermore, within such a networked environment, it will be appreciated that program modules depicted relative to the Command Center 20, or portions thereof, may be stored in the memory storage devices of the remote devices. It will also be understood that interface devices may also be used to establish links with devices lacking processing power, for example, an interactive voice response (“IVR”) system may be used to allow a conventional telephone to be interfaced with the Command Center 20.

To manage service requests, acts and symbolic representations of operations will be performed by the processing devices illustrated in FIG. 1. As such, it will be understood that such acts and operations, which are at times referred to as being computer-executed, include the manipulation by the processing devices of electrical signals representing data in a structured form. This manipulation transforms the data or maintains it at locations in the memory system, which reconfigures or otherwise alters the operation of the processing devices 20, 64, 66, 68, and 70 in a manner well understood by those of skill in the art of computer systems. The data structures where data is maintained are physical locations of the memory that have particular properties defined by the format of the data. Nevertheless, while described in the foregoing context, this description is not meant to be limiting as those skilled in the art will further appreciate that various acts and operations described herein may also be implemented in hardware.

By way of further example, the subject system and method may be implemented using a tiered architecture where one tier includes a front-end data base and Web applications running on Web server(s) that constitute an interface between users and the back-end of the system. In this manner, authorized users may access the system through a Web browser having a graphical user interface, for example, provided by a Java applet or as a common HTML page. To secure the system, the Web application may be surrounded by a firewall. The application logic would then constitute a further tier and may reside on a cluster of application servers including all of the capabilities necessary to support multiple transactions simultaneously.

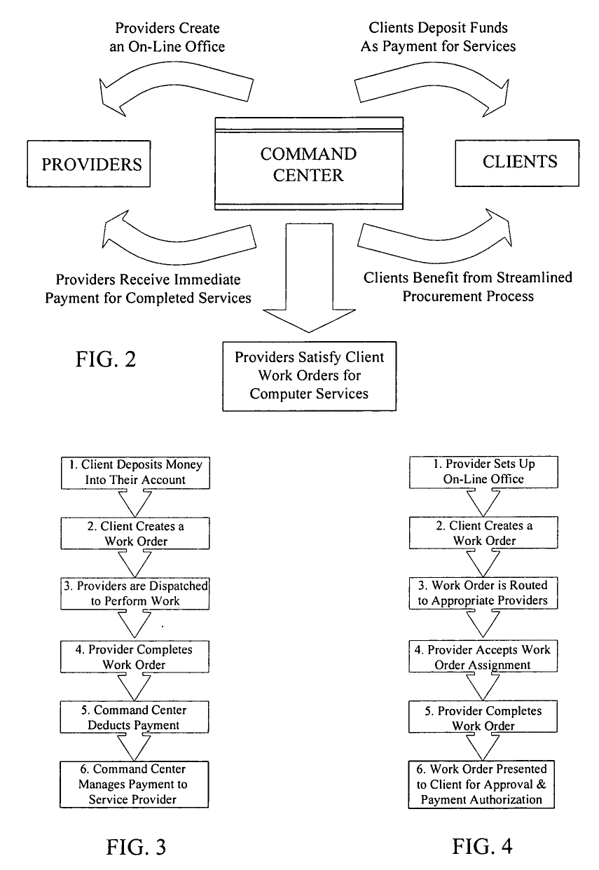

For use in controlling, building, and deploying a scalable workforce to solve service related problems, the Command Center 20 is used to provide an essentially automated system to link service requesters, e.g., corporate help-desk managers, with service providers, e.g., computer repair technicians. To this end, the Command Center 20 operates to provide a networked supply chain management system by which a service buyer may choose, for example via the Internet, one or more service providers, monitor the work performed by the service provider, and remit payment to the service provider(s) as generally illustrated in FIG. 2. It is also contemplated that the operator of the Command Center 20 would receive a fee on each transaction from one or both of the service provider (e.g., a percentage of invoice amount) and the service buyer (e.g., a flat fee). It is also contemplated that the operator of the Command Center 20 may provide fee services to companies whereby the operator of the Command Center 20 essentially functions as a centralized help desk and arranges for service providers to meet the needs of service requesters.

For a service buyer to become a system client the service buyer preferably registers with system, for example, by accessing a Web site maintained by the Command Center 20 using client computer 64 and by providing information requested by the Command Center 20. This information may include, but need not be limited to, preferred fees, geographic locations, preferred service providers, preferred hours of availability, preferred certifications, identification of employees that are authorized access, etc. As generally illustrated in FIG. 3, the operator of the Command Center 20 may also require service buyers to deposits finds into an account accessible by the Command Center 20 for reasons that are described in further detail hereinafter. Management of deposit account funds may be performed directly by the Command Center 20 or the Command Center 20 may interact with one or more financial institution computers 70 for this same purpose as described, for example, in U.S. patent application Ser. No. 10/692,181, entitled “System And Method For Managing Accounts Payable,” which is hereby incorporated by reference in its entirety. Among other things, the registration of the service buyer as a client of the system addresses a need for companies to have a single point of contact and solves the problem of payments to, and management of, multiple vendors. Registration information may be stored and accessed by the Command Center 20 directly or by means of cooperation with a database server computer 68.

Once a service buyer has registered with the system, service buyers will be able to link to the Command Center 20 to perform tasks such as, for example, updating and/or changing registration information, forming a web page, generating a service request, precisely identifying service personnel that the service buyer desires to meet their service request, managing and following up on service requests, paying the service providers (e.g., requesting a withdraw against their deposit), negotiating service contracts, and/or providing feedback on each service provider. In this regard, service buyers may access the Command Center 20 by means of the Internet, e.g., by accessing a Web site page maintained by the Command Center 20, and/or through the use of APIs that function to directly interface client computer 64 with the Command Center 20.

For a service provider to become a client of the system, as illustrated in FIG. 4, the service provider also preferably registers with the system, for example, by accessing a Web site maintained by the Command Center 20 using technician computer 66 and by providing information requested by the Command Center 20. In this regard, the service provider may be requested to provide information to create an account with the Command Center 20 as well as information that will become available via an on-line office to potential service buyers. To these ends, the Command Center 20 may collect information concerning a service provider company and/or information concerning individual employees of the service provider. Thus, information collected during the registration process may include contact information for the company and/or individuals, employee skill sets, geographical locations for service areas, availability times, rates, response times, certifications, languages spoken, etc.

As noted, once such registration information has been collected, a service provider will have the equivalent of an on-line office with the Command Center 20 which is accessible by service buyers. While information concerning a registered service provider may also be viewable by the general public, i.e., a non-registered service buyer, such information is preferably limited to prevent a viewer from contacting the service provider outside of the system, e.g., contact information may be prevented from being displayed. Access to the on-line office can be made directly via the Command Center 20 and/or by the service provider causing URLs relating to the service provider to be redirected to their on-line office as maintained by the Command Center 20. Again, the on-line office preferably contains information that would be viewable by potential service requesters such that a potential service buyer can discern if a particular service provider is appropriate for a given service need.

For requesting services, a service requester may contact the system for the purpose of creating a work order. For example, this may be performed by a service buyer supplying information to the Command Center 20. In this regard, the Command Center 20 may be contacted via any means such as, for example, accessing the Command Center 20 Web site via a processing device (e.g., client computer 64) contacting Command Center 20 personnel via telephone, PDA, facsimile machine, e-mail, paging network, radio telephone, or the like. In these latter instances, the Command Center 20 personnel may be required to then manually enter the service request information into the Command Center 20 for the purpose of allowing the Command Center 20 to create a work order.

To direct work orders to intended recipients, the Command Center 20 may cause work orders to be transmitted to one or more of a technician computer 66, telephone, PDA, facsimile machine, e-mail account pager, etc. of a service provider. The recipient service providers may then respond to the Command Center 20 to indicate a desire to answer the service request. Preferably, the service provider that is first to respond to the Command Center 20 and which is qualified to perform work associated with the service request is awarded the service request contract. Prior to and/or after the assigning of a service request, a service buyer may access the Command Center 20 to monitor all service logistics in real-time. For this purpose, any received service requests and/or work orders may be assigned a look-up number which would be transmitted to the service buyer. The service buyer may then indicate the look-up number to access status information maintained by the Command Center 20.

When the service request that is the subject of the work order is completed by the service provider, information concerning the completed service request is provided by the service provider to the Command Center 20 using any of the communication methodologies described previously. The Command Center 20 may then issue a notification to the service buyer which notification would contain information relevant to the completion of the service request/work order. Again, the service request/work order completion notification may be issued to the service buyer by being transmitted to one or more of a client computer 64, telephone, PDA, facsimile machine, e-mail account, pager, etc. of the service buyer.

In instances where the service provider is unable to complete the work order, for example, if a particular part must be replaced that needs to be specially ordered, the system may allow for the service provider to request that the work order be renegotiated with the service buyer for the purpose of addressing these additional needs. This negotiation may be done via message exchanges through the system or done directly between the parties. In either case, the system should be notified as to any changes or alterations to the work order so as to allow for the updating of the work order to ensure proper accounting. It is also contemplated that, in this case, the parties may agree that the work order is completed for purposes of accounting only and that the service buyer will issue a further service request for the purpose of having the work completed in actuality.

As discussed above, the present invention seeks to allow users to use enhanced methods to refine and characterize themselves through their profiles. While most of the discussion below addresses the processes of producing enhanced profiles for service providers, the present invention can also be applied to systems where service buyers enhance their profiles with similar benefits which are discussed below.

The present invention is a complete renovation of how providers in other systems specify their abilities, indicate their work order interests, and market themselves to buyers. Unlike the prior profiles, which required providers to indicate the exact categories of work orders which they wished to receive, the profiles of the present invention instead allow a provider to describe their abilities and work interests in a language that is a bit closer to how they market themselves to buyers outside of the system.

The intention of the present invention is to better describe both the work that a provider can do and, as importantly, the work that they are interested in doing through the service request system. The new profile works in conjunction with the new category structure to enable far more accurate matching of buyers and providers. The tools and interfaces of the present invention enable providers to fill out their service profiles so that they are also greatly streamlined and intended to make the process fun and easy, though still requiring thought and care. The present invention enables a provider to subscribe to work order categories which they are capable of completing.

The present invention also decouples the profile from the work order categories in a way that was not previously available. This decoupling provides significant flexibility to modify and evolve the matching and routing process, and to evolve the category structure and profile structure over time to expand the services available through the system. The routing process can also incorporate much more intelligence and feedback based on both a buyer's use of and a provider's performance and activities within the system.

The present invention draws upon a number of other industries/fields and the affordances and processes they employ to build a novel and unique mechanism to power the system including: strategy gaming (profile definition), online dating (matching), social networking (profiles), artificial intelligence and machine learning (matching, routing), competitive marketplaces and complex data visualization.

To create a profile, a provider supervisor creates an account through their Service Profiles List page, which also leads the provider supervisor through the process of creating a profile. To completely create a new profile, a supervisor should step through the following pages: User Settings, Service Profile Skills, Point of Sale Brands (optional, depends on skill selection), Printer Brands (optional, depends on skill selection), Voice Over IP Brands (optional, depends on skill selection), Additional Service Profile Information, Work Order Preferences and Certifications. All of these pages are described in greater detail below. After each page, the information is saved, and a supervisor can stop part way through the process. If the supervisor doesn't complete the process, the system should save the information that is entered. A supervisor can return to the Service Profiles List page and continue the process of creating the profile (they should start on the User Settings page, and information should be prefilled for those pages that they already have completed and saved), however they cannot get to the Service Profile Review page unless they complete the steps to create a profile at least once. Partial profiles do not have a public profile page.

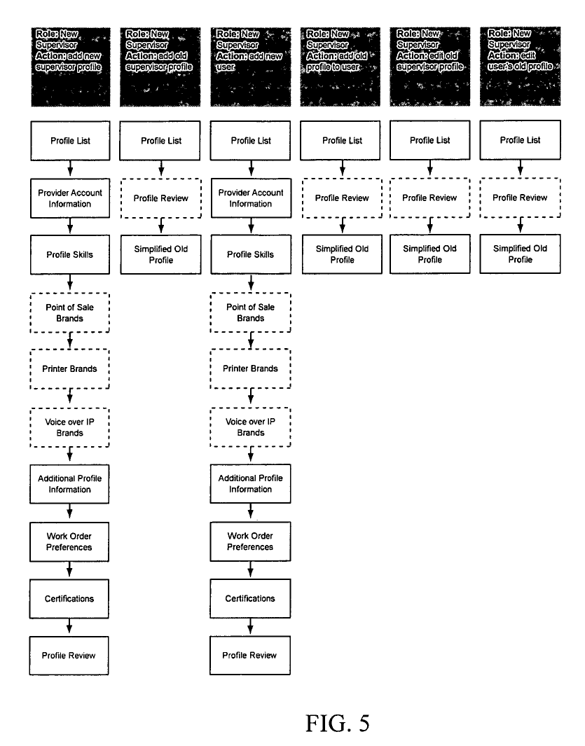

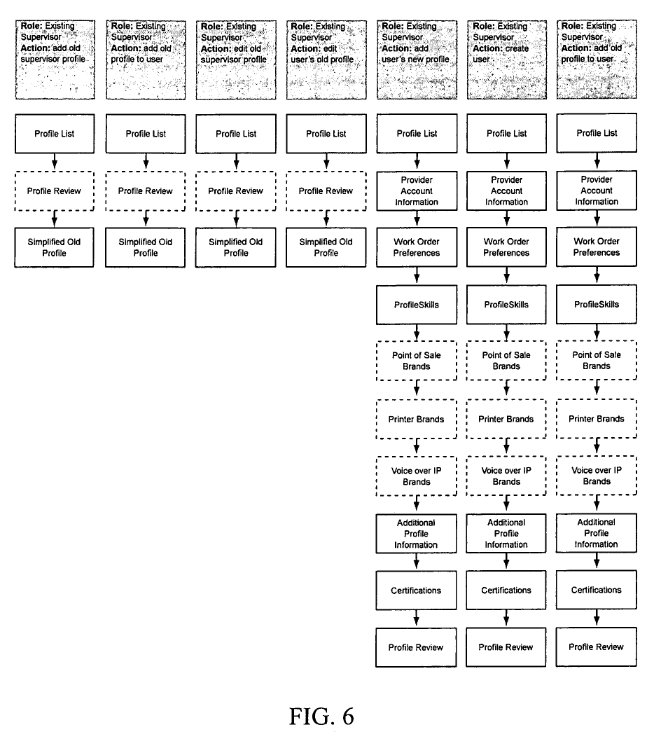

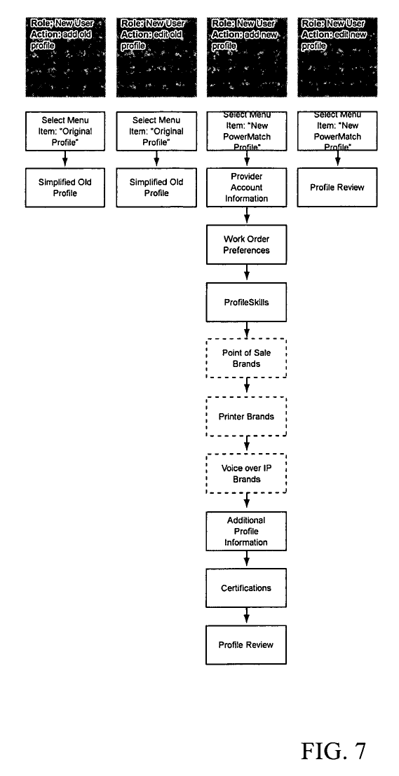

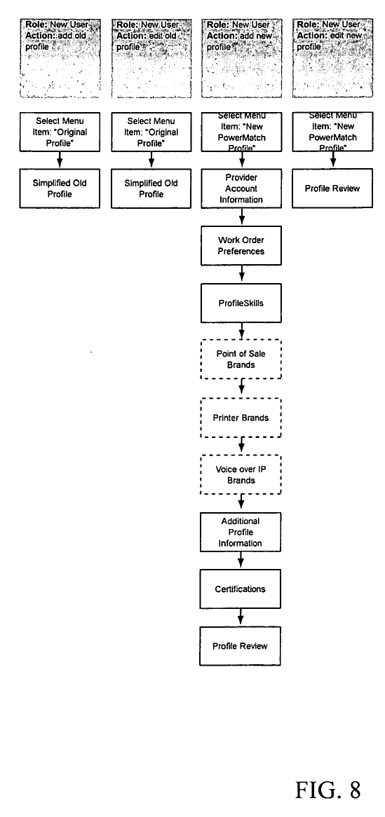

Once a supervisor creates an account, regardless of whether they have finished the creation process for the rest of the profile, that provider user should be able to log in and finish creating the profile. Once a profile is complete, that profile must be submitted to the system administrator for approval before it can be active in the system. Once approved, a profile can be set to either active or inactive status. If a profile is not approved, the profile must be updated and resubmitted it for approval. The process is also illustrated in FIGS. 5-8.

On the User Account menu, users should see 2 options: Original Service Profile and New Service Profile. If the user clicks on “New Service Profile,” and they don't yet have a new service profile, they should be taken through the profile creation process. If they already have a new service profile, they should be taken to the Service Profile Review page. The general profile approval process should be identical to the implemented process discussed above, except that the provider profile should display a new service profile if one is available.

The old provider profile can be split into 4 components, with only one of which will retain the “profile” label: Provider Account, Service Profile, Work Order Preferences and Certifications. Each is discussed in greater detail below.

A provider account is made up of the following elements: Account Information, which contains the specifics needed to login to the system, Personal Information, which contains personally identifiable information and contact information, Subscriptions, which allow the user to opt-out of system email subscriptions, and Session Timeout, which contains the details about the auto-logout settings for the provider. An account activation email should be sent out once the user account has been created. For example, the Session Timeout option may provide a list including times from 30 minutes to 12 hours, before the user is timed-out of the system.

A provider profile is made up of a number of different components, including skills, account information, hourly rates, and supplemental information. Though certifications and work order preferences are bundled with profile information in the providers profile editing screens and profile creation process, technically they are separate and distinct from a provider's profile. Service profiles are linked 1:1 with user accounts. Provider supervisors are special types of provider users that may or may not have profiles associated with them, and are created when a user creates a new Online Office. Standard provider users must have a profile associated with them. Provider supervisors are the only users that can create profiles. Each provider supervisor can create a single profile that is associated with their user account. Creating a profile involves creating a user account and the profile in a single process.

Skills define the basic profiling element for a provider. Each skill is made up of an action and an object (similar to Categories), however there is only a single level for both actions and objects. Skills are intended to delineate actual abilities that a provider may have, as well as to logically segment the types of work that is available through the system. The skills that may be listed include specialization of home/residential vs. office/business, consultation, data migration, data recovery, diagnose & repair, install/setup, parts swap, training and upgrade/tune up.

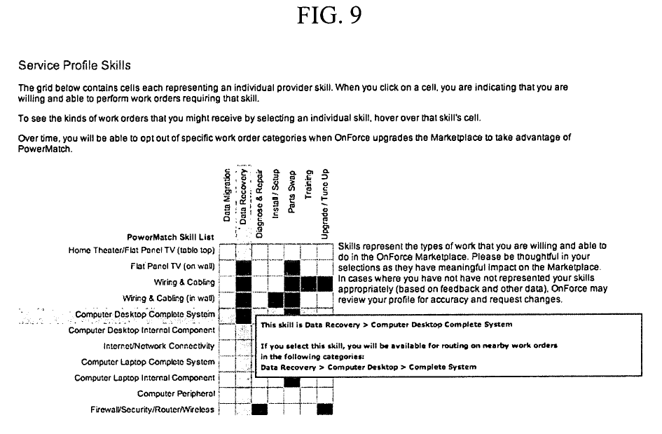

As shown in FIG. 9, the actions are defined as part of a 2 dimensional grid that also defines a single level of object classes 902 upon which the actions 904 can take place: alarm systems/closed circuit TV, home audio/home theater/satellite/projector/flat panel TV (table top), flat panel TV (on wall), wiring & cabling, wiring & cabling (in wall), computer desktop complete system, computer desktop internal component, Internet connectivity—Office, Internet connectivity—Residential, computer laptop complete system, computer laptop internal component, computer peripheral, network connectivity, firewall/security/router/switch/hub/VPN/wireless—Office, firewall/security/router/switch/hub/VPN/wireless—Residential, kiosk, digital signage, point of sate, printer, copier, multifunction—Residential, printer, copier, multifunction—Office (Basic), printer, copier, multifunction—Office (High End), external storage (NAS/SAN)/backup storage systems (Basic), external storage (NAS/SAN)/backup storage systems (High End), server hardware complete system/server rack/cabinet/UPS, server hardware internal component, server software, desktop software—General, desktop software—adware/spyware/virus removal/tuneup, desktop software—security/VPN/firewall, operating system, VoIP/telephony Residential, VoIP/telephony Office—Router, VoIP/telephony Office—phones/terminals/hardware, and VoIP/telephony Office—software.

The intersection point between a profile action 904 and a profile object class 902 is called a skill. Each skill maps into one or more work order categories through a one-to-many relationship. For each skill, two values are defined. The first value is a subscription flag that indicates if a provider has subscribed to that skill within their profile. The second value ranges from 0 to 1 (or possibly from 0 to 100, though creating relaxation, decay, and growth formulas is easier in floating point space) and is an approximate measure of that provider's abilities in that skill. The ability component of the profile element will be maintained automatically by the system based on the provider's acceptance and performance on work orders within the related categories over time. This automatic tracking of performance is used to inform the matching algorithm used when creating and sorting a work order routing list.

Certain objects conditionally enable brand specification for use within certain categories. By selecting any of the indicated objects for any action, the brand selection for that class of object will be enabled for the provider, as discussed below. These brands can include point of sale brands (Casio, etc.), printer brands (Canon, etc.), Voice Over IP Brands (GTE, etc.), etc.

Providers define their hourly rates based on either skill actions or skill objects. All actions can be assigned an hourly rate. If an object is assigned an hourly rate, then it should override the hourly rate of the skill. A provider should be given the opportunity to enter hourly rates for any actions that they select when specifying their skills. In addition, certain objects may be assigned an hourly rate if the provider selects any of the indicated skills, such as, wiring and cabling. When a provider specified hourly rate work order is routed to a provider, there must be a single hourly rate that applies for that provider for that work order. If there are multiple skills/objects that are applicable for that work order, the highest hourly rate should be the selected hourly rate for that provider.

Providers can also indicate that they support one or more of the following operating systems: Windows 2000, NT, XP, Windows Vista, Windows 95, 98, ME, Windows Server NT, 2000, 2003, Mac Classic, Mac OS X, Mac OS X Server, Linux, Unix, Mobile/Handheld and others. The providers can also indicate that they have additional equipment, such as cell phones, laptops and delivery vehicles, for examples.

Providers must speak a particular language fluently to be a provider with system. They can also indicate they speak one or more of the additional languages, including sign language. A photo may be provided and professional references may also be supplied. The user may also specify additional qualifications is a plain text data element. Providers should be able to enter up to a predetermined limit of characters into this element.

Providers can select only a limited number of skills. The number of skills they have available depends on the number of work orders they have done. The skill limits should be adjustable via the database, and additional levels of skill selection availability should be able to be added. Providers can opt out of receiving specific work order categories. This will be handled primarily when a provider receives a work order, where they will have a button “Don't Show Me Work Orders Like This One.” This should be handled separately from the skills part of a profile, such that a provider may select whatever skills they choose, but can opt out of certain categories independently of their skills selections. Internally, this can just be a filter list that is used after matching is done.

Work Order Preferences is made up of the following elements: notification, service location, minimum pricing and extended service range. The notification can be through email, SMS, IVR alerts or other methods. The service location provides the service range maximum as a system configured setting. The minimum pricing should include minimum spend limit text and minimum hourly rate text. The Extended Service Range section provides information about services and rate within the extended service range.

The process of routing a work order is handled through a mapping that translates between a provider's profile and work order categories. Each category maps into a single skill. Each skill may have multiple categories assigned to it. The category-to-skill mapping is provided to enhance the overall process. The new profile creation interface provides feedback to the provider about the work order categories to which they are “subscribing.” When determining which providers are available for routing a given work order, the system should collect the work order categories specified and use the mapping to determine the skills that are needed for the work order. For a work order with N categories, there will always be N or fewer skills that are specified.

The use of the provider profile occurs through a matrix, which has two axes: activity and object. The profile provides attributes of a person, including their skill set, location, geographical area of work, etc. Through definitions of skill sets, a decomposition of actions and objects can occur for a given profile. Each action and object form an active grid of their interactions using the input information. The interactions can have non-binary values, i.e. more than yes or no answer. For example, the interactions could provide further data, such as specific abilities and/or previous experiences.

The profile can then be mapped into a hierarchy of work order activity definitions. The work order module can then determine the attributes of the work order that need to be done to accomplish the work order. This acts to decouple the tasks needed for the work order from the work order itself. The power match process takes the input work order definition and uses that to perform a search of all provider profiles. The result is a ranking of providers to provide a best match for the input work order.

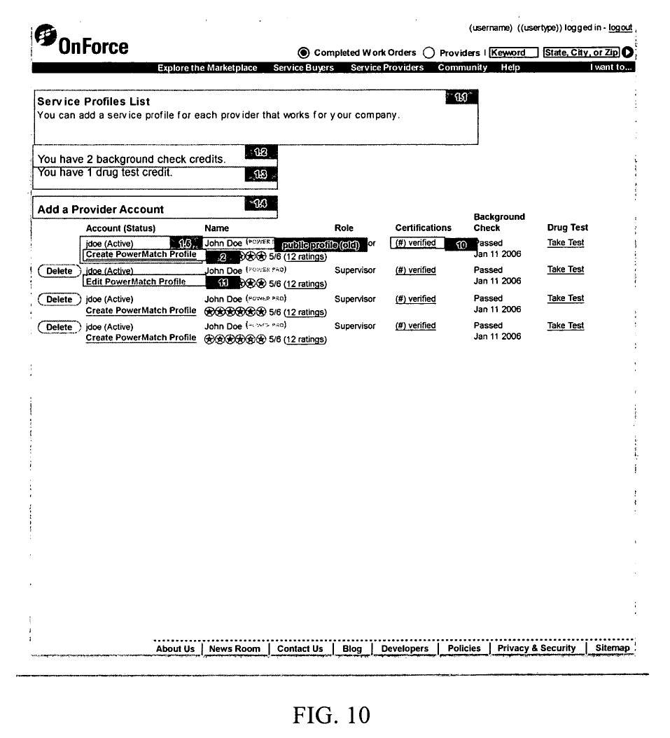

The Service Profiles List page, illustrated in FIG. 10, lists all of the provider accounts that are associated with a provider company. The page displays a table 1002 with information about each account, having columns indicating Action 1004, Account (status) 1006, Name 1008, Role 1010, Certifications 1012, Background Check 1014 and Drug Test 1016. The Action column 1004 indicates whether the provider has any work orders in progress and the Account (status) column 1006 indicating whether the account is of the new type. The Name column 1008 provides the user's name with a rating display, and the Role column 1010 indicating whether the user is a provider or a supervisor. The Certifications column 1012 indicates whether verified certifications exist, the Background Check column 1014 indicates whether has been performed and/or results, and Drug Test column 1016 indicates whether the drug test is pending or passed or failed with the date. In FIG. 10, section 1.1 provides a list of service providers, section 1.2 indicates statuses of background checks, and section 1.3 indicates statuses of drug tests. Section 1.4 indicates whether a supervisor profile exists and section 1.5 indicates whether a new type of profile exists.

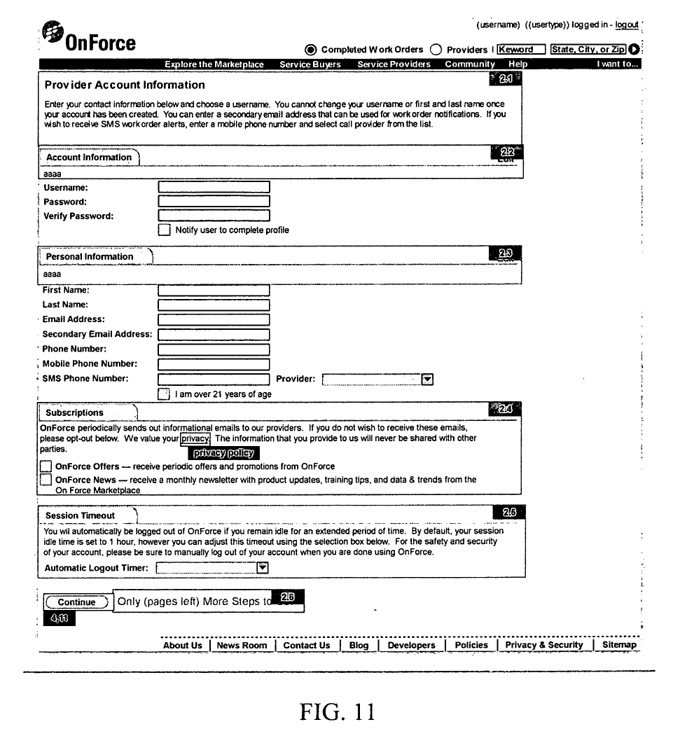

The User Settings page, illustrated in FIG. 11, enables a provider to enter their identifying and contact information, in section 2.1. The Verify Password field 1102 should be enabled upon creating an account or if the “Change Password” checkbox is checked, in section 2.2. Upon uploading a photo, the image should be automatically resized to be a maximum of 100×100 pixels. If there is a photo that already exists for this provider, it should be displayed above the choose file button, and should be automatically resized to 100×100 pixel. The “Notify user to complete profile” option 1104 should only be shown when a supervisor is creating a user, and should be unchecked. If checked, the supervisor should be taken to the User Created Page. When creating a new account, the Product Emails for Providers Activate Account email should be sent to the new user. Provider users should be required to change their passwords on first login.

If a user already has an account, and is editing or confirming their information on this page, the following fields should not be editable: first name 1106, last name 1108 and username 1110. There should also be an image upload option. If an image has already been uploaded, it should be displayed, in section 2.4. If a provider uploads a new image, it should replace the currently uploaded image. If the user is editing an existing profile (via a link from the Service Profile Review page), the Save/Continue 1112 button should take the user back to the Service Profile Review page, in section 4.11. If a user is creating a new profile, the Save/Continue 1112 button should take them to Service Profile Skills page.

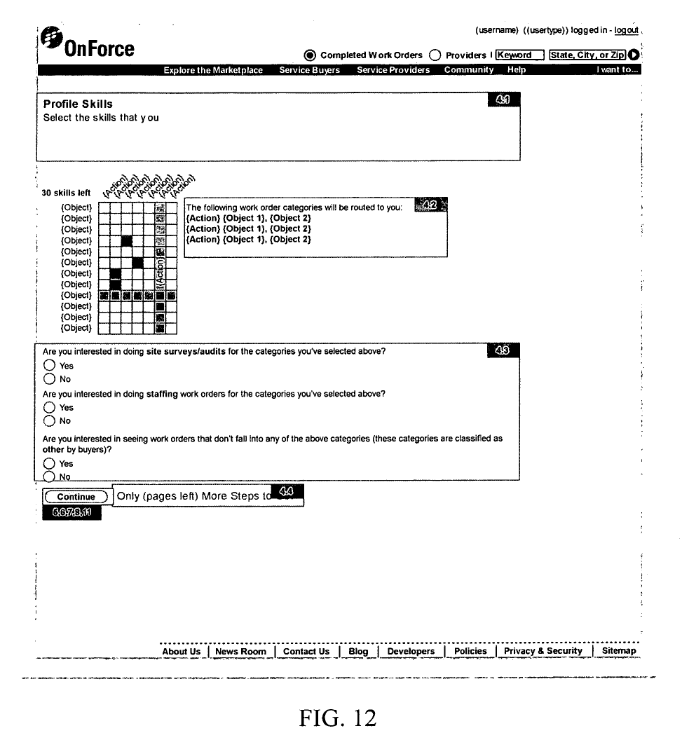

The Service Profile Skills page, FIG. 12, should allow a provider to specify the skills they have and indicate the types of work orders they want to be eligible for through the system. The interface that enables this selection is a grid 1202, with Skill Actions 1204 along the top and Skill Objects 1206 along the left side. By selecting a cell 1208, a provider indicates that they have that skill. When hovering over a cell 1208, the cell should highlight and the mapped categories for that skill should appear in the area to the right of the grid 1202. A cell 1208 can be selected or deselected by clicking in the cell.

If a user clicks and drags their mouse over multiple cells, those cells should either be selected or deselected based on the state of the first cell clicked. This should operate like a paint program with each cell acting like a large pixel. For example, if a user clicks in a cell that is not currently selected, and then drags their mouse over a few surrounding cells, all of the cells should become selected (cells that are already selected should remain so). If a user clicks in a cell that is currently selected and then drags their mouse over a few surrounding cells, all of those cells should be deselected (cells that are already deselected should remain so). When a user hovers over a row or column header, the entire row or column should highlight and the mapped categories for all skills in that row or column should appear in the area to the right of the grid. A provider can select all of the cells in a row or column by clicking on the header. Providers can only fill out a certain number of cells based on their Skill_Selection_Limits. The number of available cells should be displayed in the top left corner 1210 of the grid and should be updated dynamically. When a provider has used all of their available skill points, they must deselect a cell before they can select another cell. If the user clicks a row or column header and there are not enough skill points to allow selection of the entire row or column, as many cells as possible should be selected starting from the top left corner of the table.

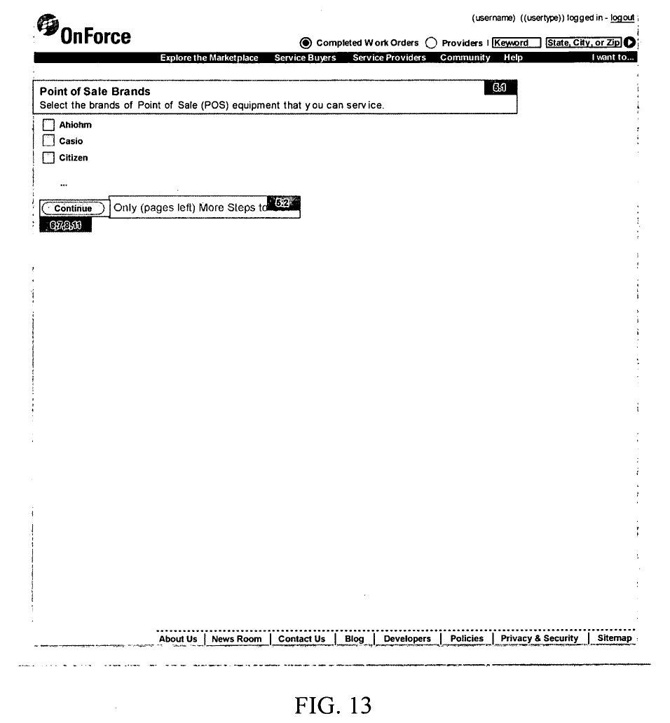

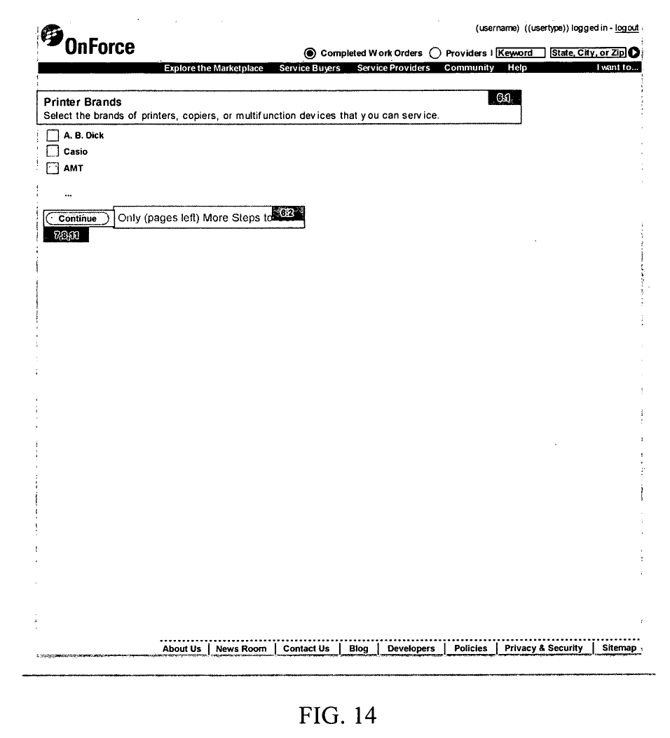

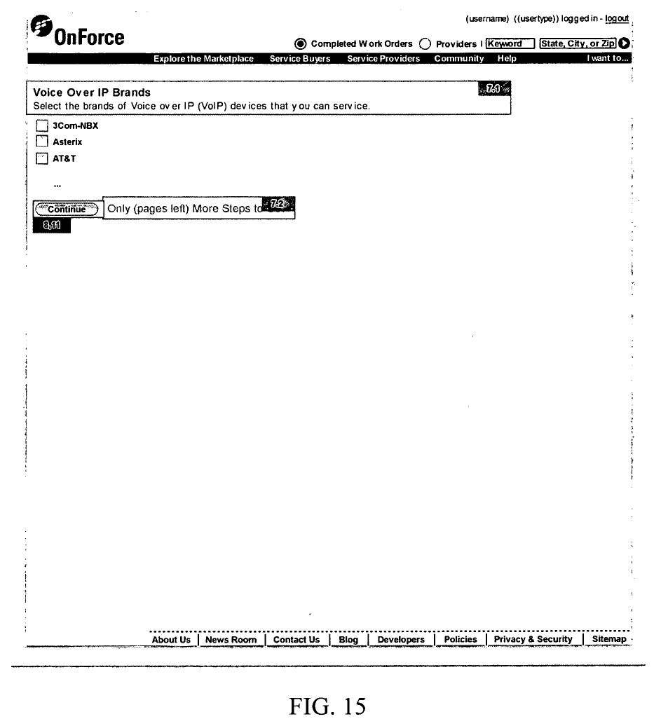

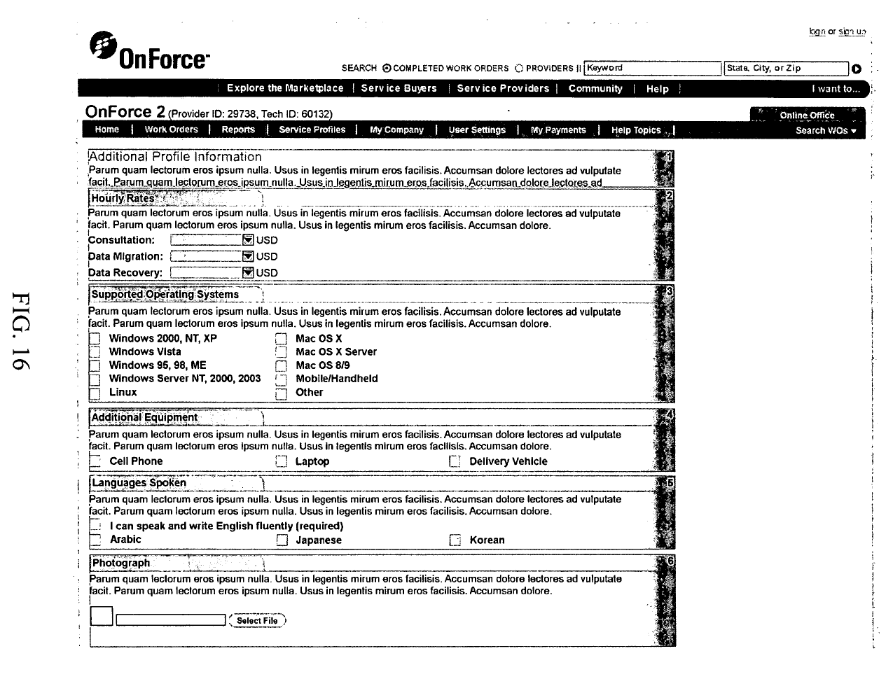

The provider can select the POS brands they service if they select any POS object skill, as discussed above. Such a page is illustrated in FIG. 13. Section 5.1 prompts for the selection of brands of Point of Sale (POS) equipment that the provider can service, section 5.2 provides for the continuation of the profile creation process with saving of the existing profile. The provider can also select the Printer brands they service if they select any Printer object skill. This page is illustrated in FIG. 14, where section 6.1 provides for the selection of the brands of printers, copiers, or multifunction devices that can be serviced and section 6.2 providing a continuation/saving option. The provider can select the VoIP brands they service if they select any VoIP object skill. This is illustrated in FIG. 15, where 7.1 selects the brands of Voice over IP (VoIP) devices that can be serviced and section 7.2 providing a continuation/saving option. Providers must affirm that they speak and write English fluently.

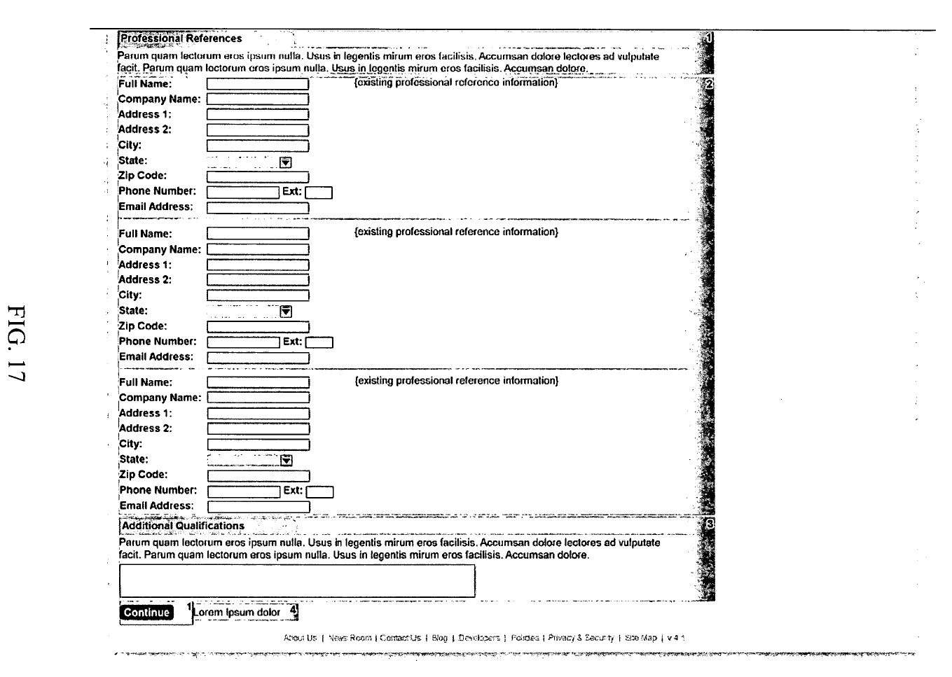

The Additional Service Profile Information Page, illustrated in FIGS. 16 and 17, provides a check box 1602 for language fluency to be acknowledged, in a Languages Spoken section, as shown in FIG. 16. That section also allows for indications of other languages spoken 1604. The Hourly Rate section indicates the hourly rates that are normally charged for the services listed 1606. The Supported Operating Systems section provides one or more operating systems that users can service 1608. The Additional Equipment section indicates which additional equipment the user has 1610. The Photograph section provides for uploading a photo to be displayed 1612. As shown in FIG. 17, the Professional References section provides for professional references 1702 and the Additional Qualifications section provides for additional qualifications 1704.

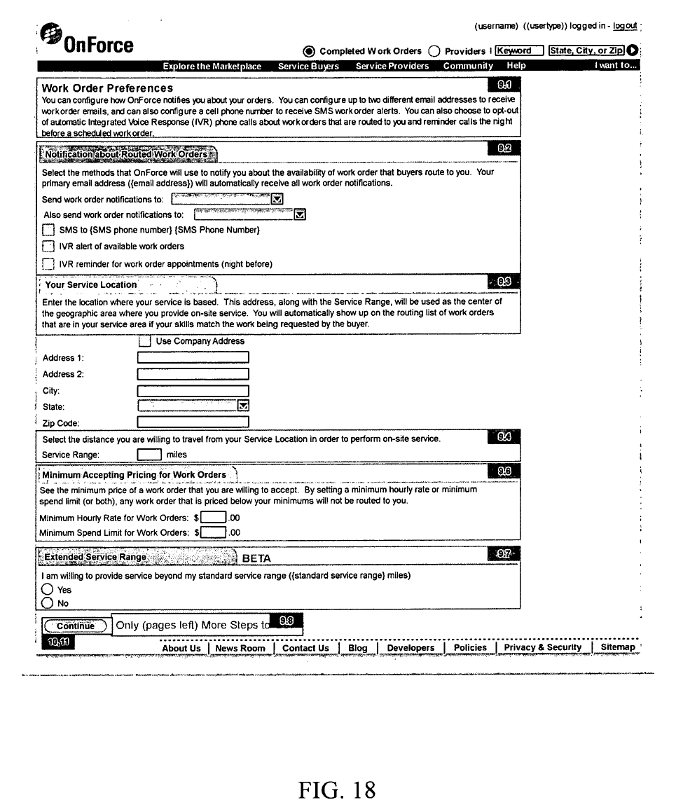

The Work Order Preferences page, illustrated in FIG. 18, enables a provider to customize how they “interact” with work orders, including how far away they are willing to travel for on-site work, and what their pricing preferences are for work orders. This page is prefilled with information from the service profile. The primary notification email address drop down list 1802 should include the primary email address and secondary email address. If a user doesn't have a secondary email address, the “Also send work order notifications to” drop down list 1804 should not appear. The extended service range 1806 should not be selected by default, and a provider should have to choose yes or no. Section 9.1 provides for Work Order Preferences on how the system alerts the user about work orders routed. Section 9.2 provides for notification about routed work orders and section 9.3 provides for your service location. Section 9.4 indicates the distance the provider is willing to travel from your service location in order to perform on-site service and section 9.6 provides for the setting of the minimum price of a work order that the provider is willing to accept. By setting a minimum hourly rate 1808 or minimum spend limit 1810 (or both), any work order that is priced below the minimum will not be routed to the provider. Section 9.7 provides the extended service range where work orders outside of a provider's standard coverage area may be routed.

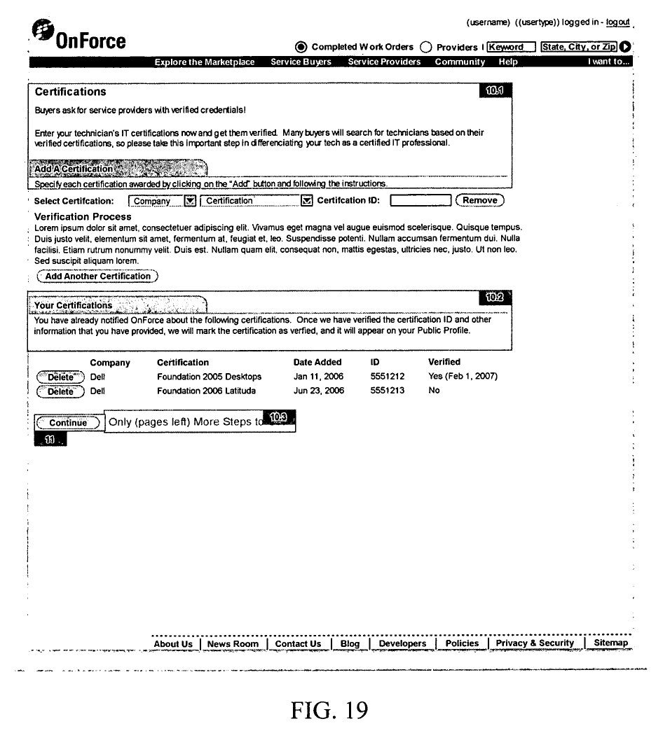

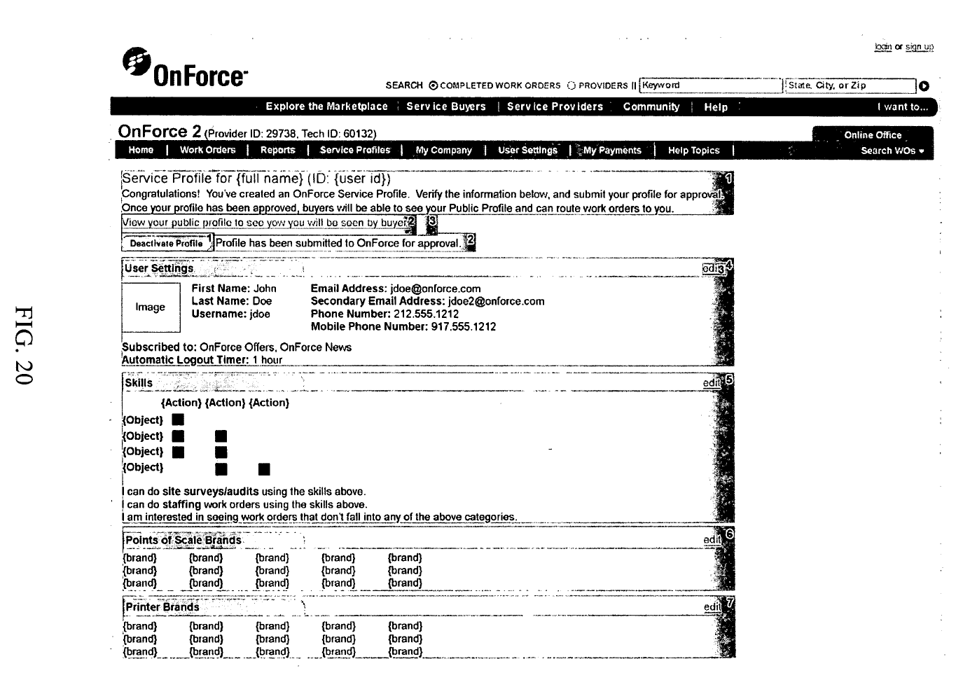

A certifications page is illustrated in FIG. 19. When adding a certification, a provider should enter the following information: certifier (required) 1902, certification (required) 1904 and a certification ID (optional) 1906. As a provider selects the Certifier 1902 and the Certification 1904, the text of the Verification Process section 1908 should be updated based on that certificates configured information. If a user clicks “Add Another Certification” 1910, a new “Select Certification” section should appear below the current one (the “Add Another Certification” button 1910 should move down to the bottom of the certification selection list). If a user clicks the “Remove” button 1912 that certification should be removed from the list. The “Remove” button 1912 should only appear if there is more than one certification selection section.

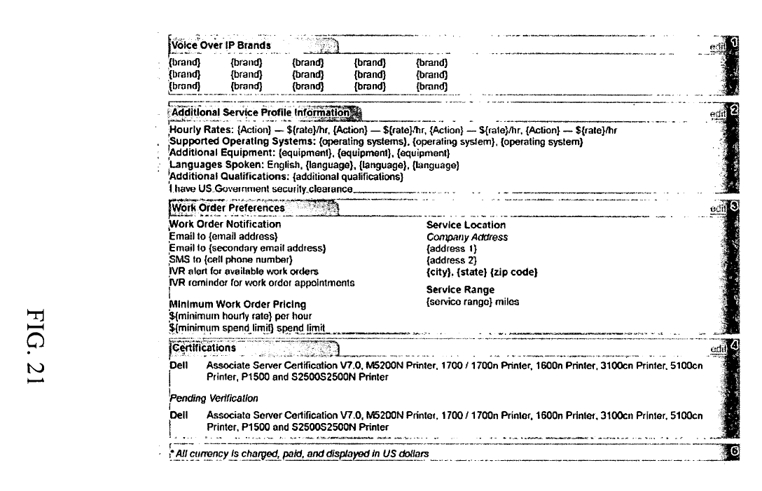

The Service Profile Review page is provided in FIGS. 20 and 21. The Service Profile Review Page displays all of the configured options for a provider's profile. Each section has an edit link 2002 that should link to that page of the profile. As shown in FIG. 20, section 1 identifies the profile by name and section 2 indicates whether the profile was submitted, approved, needs correction, is inactive, etc. Section 3 provides access to the public profile, discussed below, and section 4 provides specific account information, such as address, email, etc. Section 5 provides a list of skills in table format and sections 6 and 7 in FIG. 20 and section 1 of FIG. 21 provide experience with Point of Sale, Printer and VOIP brands, respectively. In FIG. 21, section 2 provides hourly rate information, information on experience with operating systems and a list of other equipment. Section 3 provides preferences and precedence for contacting the user by various contact methods and section 4 provides a listing of certifications.

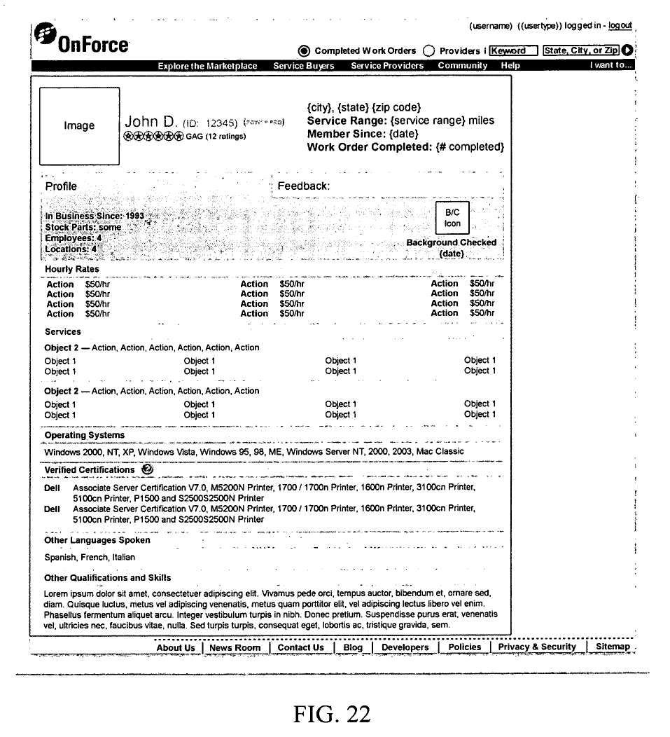

The Public Profile page, illustrated in FIG. 22, should be displayed with the following sections in the listed order. These include hourly rates 2202, services provided, by category 2204, operating systems 2206 and certifications 2208. Additional equipment, additional languages spoken 2210 and other qualifications 2212 should also be listed. All sections should be expanded horizontally to take up the full with (with padding) of the page.

Additionally, the system may enable providers to initiate background checks through affiliated entities directly through the system. This allows for users to request, pay for, submit and tracks results within the system of the present invention. The system can also allow providers to supply specific details that will be found on the background check. The system can also be set up to allow the system to automatically reject providers based on pre-established items in the report resulting from the background check. Similar functionalities can also be set up for the drug testing, described above.

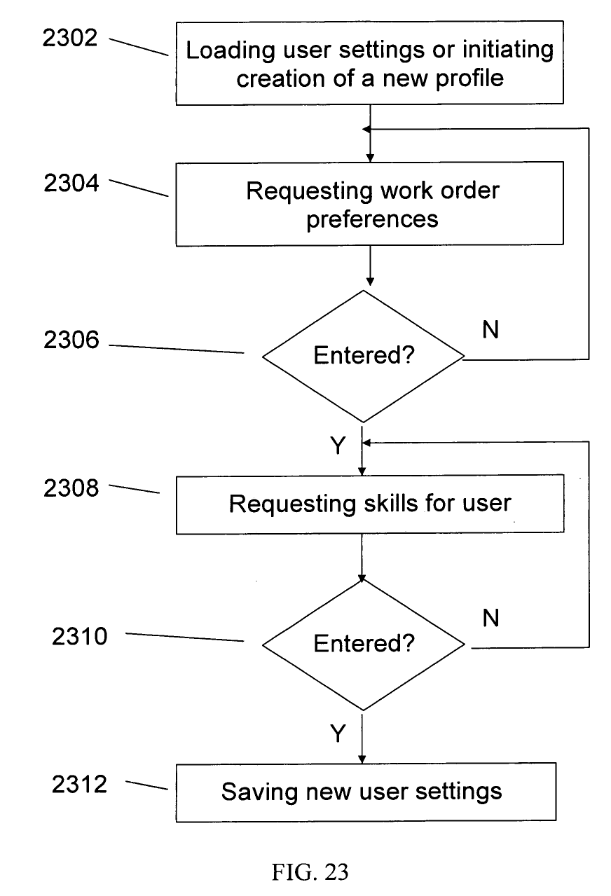

FIG. 23 provides a flow chart for the process of creating or updating user settings for service providers, according to embodiments of the present invention. In step 2302, the settings for the user are loaded or a new profile is created. In step 2304, the work order preferences are requested and the system awaits until those preferences are entered, step 2306. Thereafter, the skills for the user are requested, in step 2308, and the system awaits their entry, in step 2310. Thereafter, in step 2312, the new profile settings are saved and used in the service request system of the present invention.

From the foregoing, it will be appreciated that the subject system and method has, among others, the advantages of: providing customers with a single point of contact, responsibility, and billing. It also has the advantage of providing a convenient means, e.g., the Internet, for accessing services. The subject system and method also has the advantage of providing service requesters with a generic catalog of services, possibly at substantially reduced prices. Still further, the subject system and method may allow access to certain providers of parts and/or providers of additional services that may be required. With respect to the service providers, the subject system and method has, among others, the advantage of providing for a steady flow of work (i.e., in the form of work orders) whereby service provider personnel will be able to better manage their daily schedules, receive payments and earn more consistent pay while providing faster response times to end users. Lastly, the present invention allows for service requests and service providers to have more interaction that are specific to both parties to increase the efficiency of the transactions and provide greater satisfaction with the overall process.

While a preferred embodiment of the invention has been set forth above, those skilled in the art who have reviewed the present disclosure will readily appreciate that other embodiments can be realized within the scope of the invention. Therefore, the present invention should be construed as limited only by the appended claims.

What is claimed is:

1. A computer readable-medium for use in connection with a processing system having instructions for managing service requests, the instructions performing steps comprising:
loading profile settings for service providers, where the profile settings comprise a two dimensional matrix of actions and objects;
processing a work order by determining task involved in the accomplishment of the work order;
mapping the profile settings into a hierarchy of determined tasks of the work order; and
providing a listing of service providers for the work order through results of the mapping step.

2. The computer readable-medium as recited in claim 1, further comprising instructions for requesting additional characteristics for the service provider and including the additional characteristics in the saved, profile settings.

3. The computer readable-medium as recited in claim 1, wherein instructions for loading profile settings for a service provider comprise updating old profile settings for the service provider.

4. The computer readable-medium as recited in claim 3, wherein the step of providing a listing of service providers comprises a listing of service providers ranked by a fit of service providers with the hierarchy of determined tasks.

5. The computer readable-medium as recited in claim 1, wherein instructions for loading profile settings for a service provider comprise loading default settings for a new service provider.

6. The computer readable-medium as recited in claim 1, further comprising instructions for requesting certification information for the service provider.

7. The computer readable-medium as recited in claim 1, further comprising instructions for requesting experience information for specific brands of equipment.

8. The computer readable-medium as recited in claim 7, wherein the instructions for requesting experience information for specific brands of equipment comprises requesting experience information for at least one of point of service brands, printer brands and voice over IP brands.

9. The computer readable-medium as recited in claim 1, further comprising instructions for requesting languages spoken by the service provider.

10. The computer readable-medium as recited in claim 1, wherein two dimensional matrix of actions and objects comprises a two dimensional matrix of actions and objects having non-binary values for matrix values.

11. A method for managing service requests, the method comprising the steps of:
loading profile settings for service providers, where the profile settings comprise a two dimensional matrix of actions and objects;
processing a work order by determining task involved in the accomplishment of the work order;
mapping the profile settings into a hierarchy of determined tasks of the work order; and
providing a listing of service providers for the work order through results of the mapping step.

12. The method as recited in claim 11, further comprising requesting additional characteristics for the service provider and including the additional characteristics in the saved, profile settings.

13. The method as recited in claim 11, wherein the step of loading profile settings for a service provider comprises updating old profile settings for the service provider.

14. The method as recited in claim 11, wherein the step of providing a listing of service providers comprises a listing of service providers ranked by a fit of service providers with the hierarchy of determined tasks.

15. The method as recited in claim 11, wherein the step of loading profile settings for a service provider comprises loading default settings for a new service provider.

16. The method as recited in claim 11, further comprising requesting certification information for the service provider.

17. The method as recited in claim 11, further comprising requesting experience information for specific brands of equipment.

18. The method as recited in claim 17, wherein the step of requesting experience information for specific brands of equipment comprises requesting experience information for at least one of point of service brands, printer brands and voice over IP brands.

19. The method as recited in claim 11, further comprising requesting languages spoken by the service provider.

20. The method as recited in claim 11, wherein two dimensional matrix of actions and objects comprises a two dimensional matrix of actions and objects having non-binary values for matrix values.

21. A system for managing service requests, the system comprising:
means for loading profile settings for service providers, where the profile settings comprise a two dimensional matrix of actions and objects;
means for processing a work order by determining task involved in the accomplishment of the work order;
means for mapping the profile settings into a hierarchy of determined tasks of the work order; and
means for providing a listing of service providers for the work order through results of the mapping step.

22. The system as recited in claim 21, wherein the means for providing a listing of service providers comprises means for listing service providers ranked by a fit of service providers with the hierarchy of determined tasks.

23. The system as recited in claim 21, wherein the means for loading profile settings for a service provider comprises means for loading default settings for a new service provider.

24. The system as recited in claim 21, further comprising means for requesting certification information for the service provider.

25. The system as recited in claim 21, wherein two dimensional matrix of actions and objects comprises a two dimensional matrix of actions and objects having non-binary values for matrix values.
